(19) United States
(12) Patent Application Publication
(10) Pub. No.: US 2017/0216647 A1
(43) Pub. Date: Aug. 3, 2017

(54) DEVICE FOR CHEMICAL DRIP CONTAINMENT AND NEUTRALIZATION

(71) Applicant: Chad Lavender, McKinney, TX (US)

(72) Inventor: Chad Lavender, McKinney, TX (US)

(21) Appl. No.: 15/008,838

(22) Filed: Jan. 28, 2016

(51) Int. Cl. A62D 3/33; B65D 25/02; B65D 25/28; B01D 46/00

(52) U.S. Cl. CPC A62D 3/33; B01D 46/0089; B65D 25/02; B65D 25/28; B01D 2279/35; A62D 2203/10

(57) ABSTRACT

The device for drip containment and neutralization of chemicals includes an insert impregnated with at least one neutralizing agent, the insert is adapted to be positioned within a container. The insert comprises an air vent with a check valve and a port comprising a plug or valve to control flow of a fluid. In an embodiment, the insert may comprise a single layer or a plurality of layers, wherein each layer is impregnated with a different neutralizing agent. Neutralizing agents may be selected from a group including of bisulfite, soda ash, activated charcoal and similar agents used for neutralization of chemicals. The chemical may comprise hazardous chemical or non-hazardous chemical and the neutralizing agent is selected based on the chemical, which is to be neutralized.

### FIELD OF THE INVENTION

The present invention generally relates to containment and neutralization of chemicals, and more specifically relates to a self-contained insert for containers, which are capable of collecting, neutralizing and storing chemicals, the insert is customizable according to container type and nature of the chemical to be neutralized.

### BACKGROUND

Handling, storage and transport of chemicals involves multiple challenges regarding personnel safety, environmental hazard, and safe disposal to avoid contamination of land and water bodies. Especially, disposal of hazardous chemicals presents a significant environmental challenge. Chemicals in bulk quantities are used in industries like pharmaceuticals, semiconductor, water treatment, automotive, agriculture, car wash etc., where handling and disposal of chemicals forms a routine task.

Different types of containment systems have been used for chemical drip and spillage control, which include containment barrels, spill trays, containment sumps, spill berms, spill decks, rack storage systems, spillage absorbent pads, liquid proof films and the like. However the existing containment systems does not offer neutralization of hazardous or non-hazardous chemicals thus rendering them safe for disposal. For example, 55 gallon drums which are commonly used for storage and transport of hazardous chemicals offers only drip containment.

Chemicals leaking from a container or by products of chemicals resulting from industrial processes might comprise hazardous substances such as flammable substances, strong acids, strong bases, corrosives, oxidizers etc., and therefore required to be adequately treated or neutralized before disposal. A significant number of solid and liquid wastes are neutralized by high temperature incineration, which require expensive incinerator plants or transportation to such facilities. Other methods of neutralization involves addition of absorbents to the spilled or leaked chemical prior to cleaning off the spillage.

Therefore, there still exists a need for an improved device for drip containment and neutralization of chemicals, the device customizable according to different types of chemicals which are to be neutralized and also fit into varied container shapes.

### SUMMARY OF THE INVENTION

The present invention relates to a device for drip containment and neutralization of chemicals. The device comprises a insert impregnated with at least one neutralizing agent, the insert is adapted to be positioned within a container. The insert may include an air vent with a check valve and a port comprising a plug or valve to control flow of a fluid. Alternatively, the insert may include a device to filter gas generated and to allow the filter gas to escape the insert.

In an embodiment, the insert may comprise a single layer or a plurality of layers, wherein each layer is impregnated with a different neutralizing agent. Neutralizing agents may be selected from a group consisting of bisulfite, soda ash, activated charcoal and similar agents used for neutralization of chemicals. The chemical may comprise hazardous chemical or non-hazardous chemical and the neutralizing agent is selected based on the chemical, which is to be neutralized.

The insert may further comprise a handle fastened to a top surface, which facilitates easy placement and removal of the insert.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

FIG. 1A illustrates an insert for containment and neutralization of chemicals.

FIG. 1B illustrates the insert comprising a plurality of layers.

FIG. 2 illustrates a perspective view of the holding device of the present invention;

FIG. 3 illustrates a bottom view of the holding device of the present invention;

FIG. 4 illustrates a top view of the holding device of the present invention;

FIG. 5 illustrates an end view of the holding device of the present invention;

FIG. 6 illustrates a cross-sectional view of the holder device of the present invention;

FIG. 7 illustrates an exploded view of the holder device of the present invention;

FIG. 8 illustrates a side view of the holder device of the present invention;

FIG. 9 illustrates a perspective view of another embodiment of the holder device of the present invention.

### DETAILED DESCRIPTION OF PREFERRED EMBODIMENTS

The term “insert” or “disc shaped insert” as used interchangeably herein, refers to a structure, preferably a disc, rectangle, oval or other appropriately shaped structure comprising a porous body or a membrane or any material which can be used for allowing passage of fluid and retain neutralization agents incorporated within the structure. Although, it can be used for the passage of fluid, it may be used to capture and contain the fluid along with the neutralizer. The insert is configured to be positioned within a holding device which may be a rectangle or substantially rectangular shaped.

The term “target fluid” as used herein refers to both hazardous and non-hazardous chemicals to be contained and neutralized. The term “target fluid” may also include chemicals leaking from a container, a joint or connection point for two or more tubes, hoses or other shaped devices or from an apparatus or substances used in chemical environments.

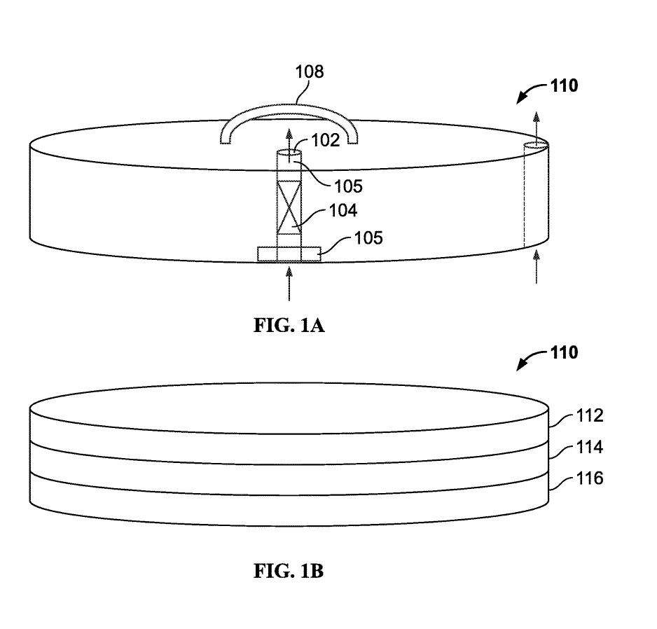

Referring to FIG. 1A, which illustrates an insert 110 for containment and neutralization of target fluid, the insert 110 comprises a disc shaped structure impregnated with at least one or more chemical agents or chemical compounds with neutralization effect. The insert 110 may comprise one or more neutralizing agents selected based on the nature of the target fluid to be neutralized. Further, the insert 110 comprises an air vent 102 which may include an O-ring 105 to provide a seal around the air vent 102 with a check valve 104 for releasing the air trapped in the area below the insert 110. The check valve 104 may include a filter 105 such as a carbon filter or other types of filters in order to filter escaping air. The insert may include a device to filter the escaping air without the check valve. The check valve 104 below the insert can be a diaphragm, ball or spring type check valve. A port 106 positioned on the edge of the insert for ease of pour of the fluid. The port 106 may include an O-ring 107 to achieve a seal.

The port 106 is configured to extend a cavity below the insert to a region above the insert, when placed in a container. The port 106 comprises a plug or a valve to control flow of the fluid. The insert 110 comprises a handle 108 fastened to the top surface, facilitates in easy placement and removal of the insert 110. The handle 108 may be positioned as to not interfere with the nesting/stacking of the insert 110, may be recessed with the top of the insert 110 and may be removable.

In an embodiment the insert 110 may comprise a plurality of layers 112, 114, 116 as shown in FIG. 1B, wherein each layer of the insert 110 is impregnated with a different neutralizing agent or a same neutralizing agent. A series of inserts can be added to neutralize a part or all of the captured target fluid. The insert 110 of the present invention is a self-contained device, adapted to function as a stand-alone catch and retain system.

In an exemplary embodiment, the insert 110 may comprise a single layer impregnated with soda ash as the neutralizing agent, which can be employed for neutralizing target fluids comprising strong acids such as sulfuric acid or hydrochloric acid, etc. In another example, the insert may comprise three layers comprising neutralizing agents such as bisulfite, soda ash and activated charcoal respectively, the multilayered insert can be employed for neutralizing biocides including chloride, chlorine dioxide, etc.

In an embodiment, the insert 110 may comprise porous material, sift style grading, semi-permeable membrane, cloth or any material that allows passage of fluid. The insert 110 is configured to neutralize target fluids comprising strong acids, strong bases, oxidizers, corrosives, flammable liquids, or any other fluid with extreme viscosity, pH, temperature or similar hazards. Insert 110 is intended to fit into existing commonly used containers such as the holding device described herein and, and also custom made to fit into containers of specific dimensions.

In another embodiment, the insert 110 may be a porous package to house the chemicals which may be in a powder or liquid form.

The chemical drip containment and neutralization insert 110 is a self-contained insert which can be placed within containers of different dimensions and shapes. The insert 110 can be placed in tapered or non-tapered containers. The dimensions of the container allow the insert to wedge into the container, the insert divides the inner space of the container into a liquid feed section and liquid collection section, above the insert. In other embodiments, the inner space may not have a liquid feed section and a liquid collection section. The insert may be positioned within the cavity and the insert may be filled with neutralizer, eliminating the need for the check valve or a mechanism to filter escaping air.

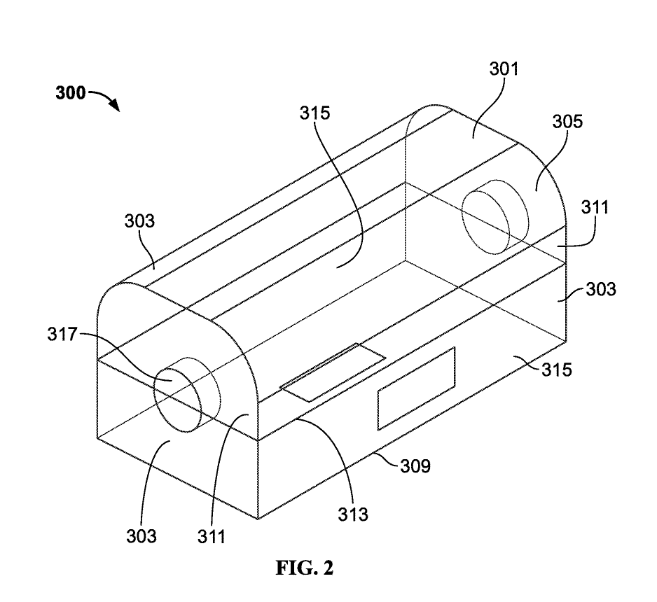

FIG. 2 illustrates the holding device 300 for holding the insert 110 which may include a cover segment 320 and a base segment 322 which may connect with the cover segment 320. The cover segment 320 and the base segment 322 may form the holding device 300 which may be curved, rectangular or other appropriate shape, a pair of mirrored end walls 305 which may connect to the top wall 301 and a pair of mirrored sidewalls 303 which may connect to the top wall 301 and the end walls 305. The base segment 322 may include a bottom wall 309 to support and hold the insert 110, a pair of mirrored end walls 311 which may connect to the bottom wall 309 and a pair of mirrored sidewalls 315 which may connect to the bottom wall 309 and the end walls 311. The sidewalls 315 may include an angled segment 313 to connect to the cover segment 320. The angled segment 313 may extend across the sidewalls 315.

FIG. 2 additionally illustrates a pair of opposing mirrored curved top walls 317 which may extend from the end wall 305 and a pair of opposing mirrored curved bottom wall 319 which may extend out of the end wall 311. Each of the curved top walls 317 connect with each of the curved bottom wall 319 to form a first collar for a first tube or pipe 341 (first fluid passageway) which may extend through the collar and into a cavity 345 which may be formed from the cover segment 320 and the base segment 322. Each of the remaining curved top walls 317 may connect with the remaining curved bottom wall 319 may form a second collar for a second tube or pipe 341. The first tube or pipe 341 may connect with the second tube or pipe 341 by a connector 343. The connector 343 may leak fluid flowing through the first tube or pipe 341 and the second tube or pipe 341 (second fluid passageway), and the leaking fluid may be absorbed by the insert 110 and treated by the material being held by the insert 110 which may be rectangular oval, circular or other appropriate shape in order to conform to the support of the bottom wall 309.

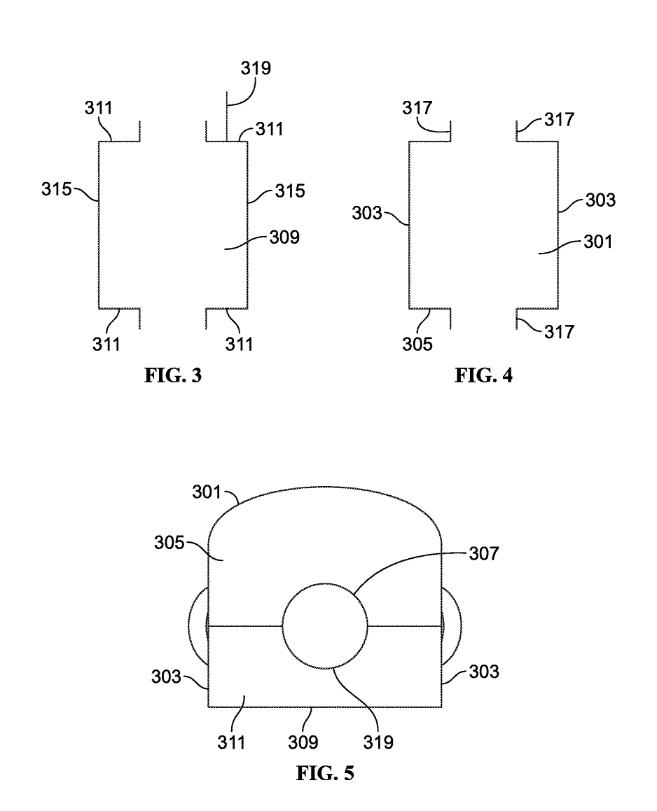

FIG. 3 illustrates a bottom view of the base segment 322 of the holding device 300 of the present invention and illustrates the bottom wall 309 which may be connected to the side walls 315 and the end wall 311. The end wall 311 may be connected to a curved bottom wall 319.

FIG. 4 illustrates a top view of the cover segment 320 of the holding device 300 of the present invention and illustrates the top wall 301 which may be convexly curved and which may be connected to the end walls 305 and the sidewall 303. The end walls 305 may be connected to the curved top wall 317 which may extend from the end walls 305 to form a collar.

FIG. 5 illustrates an end view of the holding device 300 of the present invention and illustrates the cover segment 320, the base segment 322 the top wall 301 the end wall 305, the bottom wall 309, the envelope 311 and the curved top wall 317 and the curved bottom wall 319.

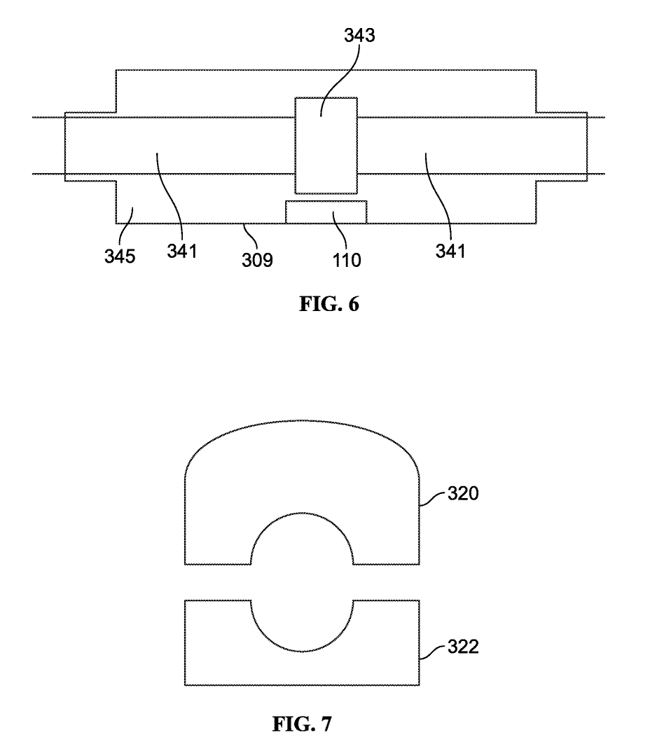

FIG. 6 illustrates a side view of the holding device 300 of the present invention and illustrates the cover segment 320 and the base segment 322. FIG. 6 additionally illustrates the top wall 301, the bottom wall 309, the end wall 305, the end wall 311, the curved top wall 317, and the curved bottom wall 319.

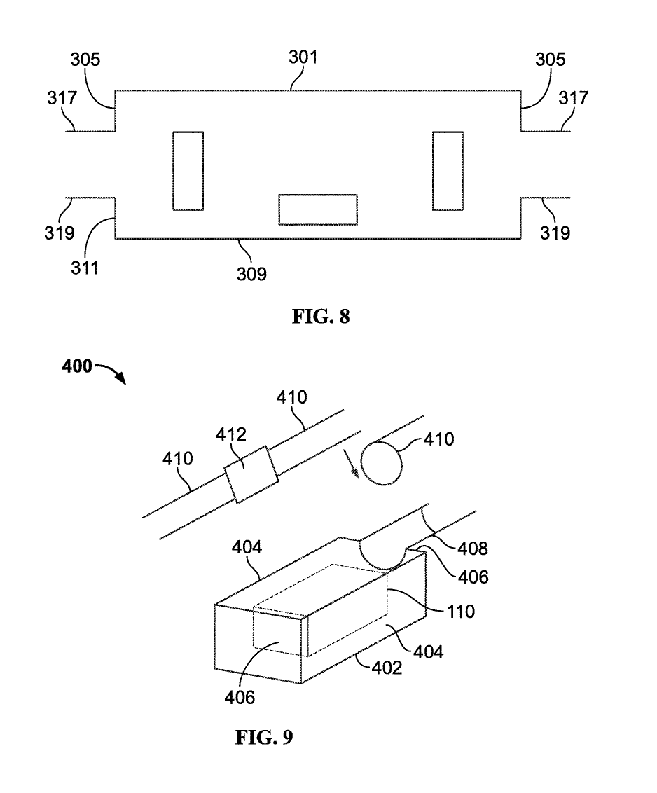

FIG. 6 additionally illustrates the aperture and straps 351 (FIG. 8) to hold the cover segment 320 and the base segment 322 together.

FIG. 6 illustrates a cross-sectional view of the holding device 300 of the present invention and illustrates the cavity 345, the tube/pipe 341 being connected by the connector 343.

FIG. 7 illustrates an exploded view of the holding device 300 of the present invention and illustrates the cover segment 320 and the base segment 322.

FIG. 8 illustrates a side view of the holder device of the present invention and illustrates the top wall 301, the end wall 305, the bottom wall 309, the end wall 311 the curved top wall 317, and the curved bottom wall 319.

FIG. 9 illustrates a another embodiment of the present invention, and FIG. 9 illustrates that first segment of a pipe 410 may be connected to a second segment of pipe 410 at a connector 412 which may be leaking chemicals which may transferred into a cavity 411 of the holding device 400 and may include the insert device 110 and may be defined by an open top, a pair of opposing mirrored sidewalls 404, a bottom wall 402 which may be connected to the sidewalls 404, and a pair of opposing mirrored end walls 406 which may be connected to the bottom wall 402 and the side walls 404. The holding device 400 may include a curved wall 408 which may be connected to the pipe 410 by a fastener such as a strap (not shown)

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A device for drip containment and neutralization of chemicals, the device comprising:
an insert impregnated with one or more neutralizing agents, wherein the insert comprises device to filter the escaping fluid;
a retaining ring placed on the insert for holding the insert when placed within a holding device; and
a handle fastened to a top surface of the insert.

2. The device of claim 1, wherein the insert is adapted to be positioned within the holding device.

3. The device of claim 2, wherein the insert is positioned in such a way, so that the insert is positioned beneath a connector connecting a first pipe and a second pipe.

4. The device of claim 3, wherein the first pipe and the second pipe extend from opposing ends of the holding device.

5. The device of claim 1, wherein the neutralizing agent is selected based on the chemical to be neutralized.

6. The device of claim 1, wherein the chemical comprises hazardous chemical or non-hazardous chemical.

7. The device of claim 1, wherein the insert comprise a plurality of layers.

8. The device of claim 7, wherein each layer is impregnated with a different neutralizing agent.

9. The device of claim 4, wherein the first pipe and the second pipe are connected to a collar.

10. The device of claim 1, wherein the holding device includes a cover segment and a base segment.

11. The device of claim 1, wherein the device for escaping fluid includes an air vent with a check valve and a port comprising a plug or valve to control flow of a fluid
